(19) United States
(12) Patent Application Publication
(10) Pub. No.: US 2026/0193109 A1
(43) Pub. Date: Jul. 9, 2026

(54) A CAVITATION PROCESS FOR DEGRADATION OF CHEMICALS IN WASTEWATER

(71) Applicant: COUNCIL OF SCIENTIFIC AND INDUSTRIAL RESEARCH, New Delhi (IN)

(72) Inventors: Vinay Manoharrao BHANDARI, Pune (IN); Divya DIXIT, Pune (IN); Pooja Diwakar THANEKAR, Pune (IN)

(21) Appl. No.: 19/133,593

(22) PCT Filed: Dec. 1, 2023
(86) PCT No.: PCT/IN2023/051126

§ 371 Date: May 28, 2025

(30) Foreign Application Priority Data
Dec. 2, 2022 (IN) 202211070214

(51) Int. Cl. C02F 1/34; C02F 1/72; C02F 101/30

(52) U.S. Cl. CPC C02F 1/34; C02F 1/722; C02F 2101/30; C02F 2201/002; C02F 2209/02; C02F 2209/03; C02F 2209/06; C02F 2209/44; C02F 2305/023

(57) ABSTRACT

The present invention relates to reactors having catalytic activity for increased reaction rates and degradation of pollutants/chemicals. Specifically, the present invention relates to catalytic cavitation process and catalytic cavitation reactor apparatus with or without novel metal or metal oxide coating on inner side of the cavitation reactor for improved reactions/degradation of pollutants and process.

### FIELD OF THE INVENTION

The present invention relates to a cavitation process for chemical reactions such as degradation of pollutants/chemicals in wastewater. Particularly, the present invention relates to dual activity cavitation reactor with coating on inner side of the cavitation reactor for increased rates of chemical reactions such as improved degradation of pollutants and process for degradation of pollutants/chemicals thereof.

### BACKGROUND OF THE INVENTION

Increased rates of reaction are an advantage in the industries due to reduced reaction times and subsequently processing cost.

Pollution due to antibiotics is growing concern, attracting increased attention in recent years. Normally implemented physical, biological, chemical or physico-chemical methods to treat pollution do not seem to be very effective to in treating pollution due to various chemicals/pollutants of the antibiotics class.

Numerous studies have shown low degradation levels with low degradation rate for wastewater technologies based on physical, chemical, or biological treatment processes including various advanced oxidation processes (AOPs) such as electrochemical treatment [E. Aseman-Bashiz et al., J. Mol. Liq. 300 (2020), 112285,], UV photolysis (direct & indirect) [Y. Gu, et al., Front. Environ. Sci. 10 (2023), 1071963,], ozonation [M. Scheurer et al., Water Res. 46 (2012) 4790-4802], and photocatalysis [R. Kumar, Sci. Total Environ. 751 (2021), 142302], etc. These known treatment technologies have many drawbacks including the formation of multiple and/or toxic by-products, prolonged treatment times, high operating costs, and secondary waste generation. A maximum of 89% MTF degradation with 68% total carbon reduction in 60 min was reported using the electro-activation of persulphate on a natural catalyst (pyrite) [E. Aseman-Bashiz et al.,]. A hybrid process of UV irradiation and sulfite gave 86% MTF removal in 180 min from contaminated water with initial concentration of 2.5 mg/L [Y. Gu, et al.,]. Apart from the drawback of not achieving 100% degradation, many existing treatment methodologies have limitations in the form of cost-effectiveness, secondary waste generation, difficulties in scale up etc. making them not viable treatment for industrial applications.

References may be made to Patents “U.S. Pat. No. 9,422,952B2” & “U.S. Pat. No. 9,725,338B2”, wherein cavitation devices such as the vortex diode have been reported for treating effluents. Devices and methodologies in prior arts are focused on reducing the polluting parameters of effluents such as COD, BOD, ammoniacal nitrogen and various others. However, very few studies have been conducted that focus on degradation of specific class of chemicals and the pollution arising out of them. This is of particular concern because the presence of antibiotics in contaminated water bodies may cause antibiotic resistance in humans which can lead to significant ill effects on health, even at low concentrations (ng/L to μg/L).

The efficacy of cavitational activity largely depends on efficient design of the cavitation reactors and process intensification which will address the cost issue as well as the efficiency. There is a challenge to enhance the reaction efficiency or degradation process by increasing the rates of reaction/removal or for obtaining complete removal.

Typically, synergistic techniques for pollutants, in general, and antibiotic degradation in wastewater include combinations of either ultrasound (US) or hydrodynamic cavitation (HC) and oxidative, photo-catalytic, and enzymatic strategies and removal/degradation of sulfadiazine by HC/persulfate (PS)/H₂O₂/α-Fe₂O₃, US/PS/FeO, and sono-photocatalysis with MgO@CNT nanocomposites processes; the degradation of tetracycline by US/H₂O₂/Fe₃O₄, US/O₃/goethite, and HC/photocatalysis with TiO₂ (P25) sono-photocatalysis with rGO/CdWO₄, degradation of amoxicillin by US/Oxone®/Co²⁺ etc. were reported. However, the removal of antibiotics was low using conventional cavitation methods and catalytic methods such as US-assisted laccase-catalysis also showed limitations in achieving complete degradation.

The existing methods can be classified as:
a) Biological Methods using biocatalysts.
b) Physico-chemical methods such as catalytic oxidations etc.
c) Adsorption/ion exchange.
d) Cavitation is a physico-chemical method that works on the principle of in situ generation of oxidizing agents for oxidative destruction of species. It has limited commercial viability due to various process efficiency and economic issues.

The conventional processes have limitations in terms of lower efficiency and due to high costs and operational constraints. Many methods have only partial removal ability for the refractory pollutants such as antibiotics and also have limited degradation capacity. The conventional Catalytic process have their own issues in terms of catalyst, selection, concentration, cost and operating conditions etc. apart from separations and reaction/degradation efficiency.

The developed reactors are starkly different in terms of material or surface coating of the cavitating device that provides additional function due to the catalytic activity of the reactor or the coated materials, while the other aspects in terms of method of operation remain essentially, the same. Thus any conventional cavitation process can be modified by appropriate use of material for effecting various catalytic reactions including degradation.

Though cavitation method is known to remove common pollutants such as dyes and the like, its modification, in the form of dual activity or catalytic cavitation process and reactors, as invented here for the increased reaction rates and for the removal of pollutants, enhanced reaction/degradation efficiency, especially for the removal of antibiotics, in general, and complete degradation, in particular, has not been reported anywhere.

Therefore, there is an imminent need to design a cavitation reactor without substantially altering the original design that can offer effective, enhanced reaction efficiency, in general and complete degradation of pollutants, in particular.

The present invention satisfies the existing needs, as well as others, and generally overcomes the deficiencies found in the prior art.

### OBJECTS OF THE INVENTION

Main object of the present invention is to provide a process for degradation of pollutants/chemicals from wastewater.

Another object of the present invention is to provide a cavitation process for degradation of pollutants in wastewater.

Yet another object of the present invention is to provide a catalytic cavitation reactor apparatus with coating on inner side of the cavitation reactor for increased reaction rates and improved degradation of pollutants from wastewater.

Yet another object of the present invention is to provide a process for degradation of pollutants from wastewater using the dual activity cavitation reactor apparatus with coating on inner side of the cavitation reactor.

Yet another object of the present invention is to provide a process for degradation of pollutants from wastewater using the cavitation reactor apparatus with coating on inner side of the cavitation reactor with or without process intensification.

Yet another object of the present invention is to provide a dual activity process and cavitation reactor apparatus for disinfecting wastewater or any other contaminated solutions, which are harmful for environment/public health.

### SUMMARY OF THE INVENTION

The present invention relates to a cavitation process for degradation of pollutants and reactors having catalytic activity for reactions/degradation of pollutants. Specifically, the present invention relates to cavitation process for degradation of pollutants in wastewater comprising: introducing wastewater in a cavitation reactor; and contacting the wastewater in a cavitation reactor having a coating on inner side(s) of the cavitation reactor under reaction conditions to degrade the pollutants; wherein the cavitation process intensification by using H₂O₂ and/or pH alternations in the range of 4 to 14.

Accordingly, present invention provides a cavitation process for degradation of pollutants in wastewater comprising:
a. introducing 10 mg/L to 30 mg/L wastewater having pollutants in a cavitation reactor; and
b. contacting the wastewater in a dual activity cavitation reactor having a coating on inner side(s) of the cavitation reactor at a pressure drop is in the range of 0.5 to 2 bar, in presence or absence of H₂O₂, at a pH in the range of 4-14 and temperature in the range of 0 to 200° C. for a period in the range of 5 min to 90 min to degrade the pollutants.

In an embodiment of the present invention, the cavitation reactor is made of a material selected from a group consisting of metal, glass, tile, stone, polymer, quartz, plastic, ceramic surfaces, polymeric surfaces and combination thereof.

In another embodiment of the present invention, the cavitation reactor is a hydrodynamic cavitating device made up of a metal selected from copper, aluminium, stainless steel and the like.

In yet another embodiment of the present invention, the cavitation reactor is selected from orifice, venturi, vortex diode, rotating impeller and the like.

In yet another embodiment of the present invention, the coating is comprised of a metal selected from a group consisting of Fe, Cu, Co, Ag, Ni, Au, or salts thereof, and combination thereof, preferably Cu, Ag, and Ni.

In yet another embodiment of the present invention, the coating has a thickness preferably in the range of 10 μm to 100 μm.

In yet another embodiment of the present invention, wherein step (b) is carried out optionally with ion exchange, alum treatment, Fenton, electro-Fenton, photo-Fenton, ozone, Cl₂, ClO₂, or anaerobic and aerobic biological oxidation.

In yet another embodiment of the present invention, the pollutants are organic compounds.

In yet another embodiment of the present invention, the pollutant and H₂O₂ molar ratio is preferably in the range of 1:100 to 1:1000.

In yet another embodiment of the present invention, the present invention provides a method for creating a metal or mixture of metals coating on cavitation reactor apparatus.

In yet another embodiment of the present invention, the cavitation reactor apparatus with/without surface coating is used in combination with ion exchange, alum treatment, Fenton, electro-Fenton, photo-Fenton, H₂O₂, ozone, Cl₂, ClO₂, and anaerobic and aerobic biological oxidation.

In yet another embodiment of the present invention, the process for degradation of pollutants in wastewater operates at nearly ambient conditions, with the reactor/metal coating acting as a catalyst. The process can yield up to 100% degradation and is useful even at very high concentrations.

In yet another embodiment of the present invention, the dual activity cavitation reactor apparatus with/without surface coating effected with pollutant: H₂O₂ ratio ranging between in 1:100 and 1:1000 mol ratio results in 75% to 100% degradation of pollutant, wherein the pollutant is selected from organic compounds selected from dyes, antibiotics, and the like.

Dual activity refers to additional catalytic cavity (in addition to conventional cavitation process).

In yet another embodiment of the present invention, the process and cavitation reactor apparatus are useful for converting pollutants including antibiotics in wastewater or any other contaminated solutions, which are harmful for environment/public health into the different degradation products.

In yet another embodiment of the present invention, the process and cavitation reactor apparatus are useful for increased rates in disinfecting wastewater or any other contaminated solutions, which are harmful for environment/public health.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The following drawings form a part of the present specification and are included to further illustrate aspects of the present disclosure. The disclosure may be better understood by reference to the drawings in combination with the detailed description of the specific embodiments presented herein.

FIG. 1 represents modified acoustic cavitation process for enhanced degradation efficiency-Comparison of copper against glass, stainless steel and silver reactors, in accordance with an embodiment of the present disclosure.

FIG. 2 represents comparison of degradation of Cephalexin by various hydrodynamic cavitation options, in accordance with an embodiment of the present disclosure.

FIG. 3 represents the image of internal coating of the vortex diode by the copper and silver, in accordance with an embodiment of the present disclosure.

FIG. 4A represents the graph of degradation of Cephalexin by various hydrodynamic cavitation options including surface coated vortex diode, in accordance with an embodiment of the present disclosure.

FIG. 4B represents the graph of degradation byproducts of Cephalexin by copper coated vortex diode, in accordance with an embodiment of the present disclosure.

FIG. 5 represents the graph of disinfection by copper coated surface vortex diode compared to conventional vortex diode (A1) under similar conditions, in accordance with an embodiment of the present disclosure.

FIG. 6 represents degradation of Metformin (MTF) in cavitation using conventional and surface coated devices, in accordance with an embodiment of the present disclosure.

### DETAILED DESCRIPTION OF THE INVENTION

Those skilled in the art will be aware that the present disclosure is subject to variations and modifications other than those specifically described. It is to be understood that the present disclosure includes all such variations and modifications. The disclosure also includes all such steps, features, compositions, and compounds referred to or indicated in this specification, individually or collectively, and any and all combinations of any or more of such steps or features.

### Definitions

For convenience, before further description of the present disclosure, certain terms employed in the specification, and examples are delineated here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a” “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The present invention relates to a process and reactor having catalytic activity for degradation of pollutants. Specifically, the present invention relates to process and cavitation reactor apparatus with or without surface coating on inner side of the cavitation reactor for improved degradation of pollutants and process for degradation of pollutants thereof.

The present disclosure provides a cavitation process for degradation of pollutants in wastewater comprising:
i. introducing wastewater in a cavitation reactor; and
ii. contacting the wastewater in a cavitation reactor having a coating on inner side(s) of the cavitation reactor under reaction conditions to degrade the pollutants;
wherein the cavitation process intensification by using H₂O₂ and/or pH alternations in the range of 4 to 14.

The cavitation reactor apparatus is made of a material selected from a group consisting of metal, glass, tile, stone, polymer, quartz, plastic, ceramic surfaces, polymeric surfaces and combination thereof.

The surface of the cavitation reactor apparatus is selected from but not limited to a metal, glass, tile, stone, polymer, quartz, plastic, ceramic surfaces, polymeric surfaces and the like.

The cavitation reactor apparatus is a hydrodynamic cavitating device constructed of copper, aluminium, stainless steel and the like.

The cavitation reactor is selected from but not limited to orifice, venturi, vortex diode, rotating impeller and the like.

The coating, when present, is application of a metal selected from a group consisting of Fe, Cu, Co, Ag, Ni, Au, or metals salts and combination thereof. Most preferably, the coating metal is Cu, Ag, and Ni.

The metal or mixture of metals coating on cavitation reactor apparatus may have thickness in the range of 10 μm to 100 μm.

The cavitation reactor for the degradation of pollutants in wastewater further comprises ion exchange, alum treatment, Fenton, electro-Fenton, photo-Fenton, H₂O₂, ozone, Cl₂, ClO₂, and anaerobic and aerobic biological oxidation.

The pollutants are organic compounds. The organic compounds are selected from dyes, antibiotics, and the like.

The pollutant and H₂O₂ are in a molar ratio preferably in the range of 1:100 to 1:1000. In another embodiment of the present disclosure, the pollutant and H₂O₂ are in a molar ratio range of 1:500 to 1:1000. In yet another embodiment of the present disclosure, the pollutant and H₂O₂ are in a molar ratio of 1:500. In still embodiment of the present disclosure, the pollutant and H₂O₂ are in a molar ratio of 1:1000.

The reaction conditions comprise:
(i) a pressure drop is in the range of 0.5 to 2 bar;
(ii) temperature in the range of 0 to 200° C.;
(iii) treatment time in the range of 5 min to 90 min; and
(iv) low to high initial concentration, typically in the range of 10 mg/L to 30 mg/L.

Preferably, the pressure drop is in the range of 0.5 to 1.5 bar. More preferably, the pressure drop is 1 bar. Preferably, the temperature is in the range of 0 to 100° C. More preferably, the temperature is in the range of 10 to 50° C. Most preferably, the temperature in the range of 15 to 35° C. Preferably the treatment time is in the range of 5 min to 60 min, the samples are withdrawn in the 5-10 min interval. Preferably, the initial concentration is 20 mg/L.

The coating technologies to achieve a uniform coating include but not limited to dip-coating, spray-coating, spin-coating, Doctor Blade coating, brush coating, and the like.

The coating withstands exposure to pH values from 1 to 14, higher/lower temperatures, extreme pollutant concentrations with substantially no cracking, swelling, pitting, or decomposition.

The present invention provides a metal or mixture of metals coating for cavitation reactor apparatus.

The design and final appearance of the cavitation reactor apparatus with surface coating is largely not altered and can be followed using the conventional practice of fabrication, except for applying suitable coating of the specified metal/material and for suitable thickness.

Coating can be useful for driving the reaction, even with smaller thickness of the coating or more thickness of the coating can be considered as per the need and after the optimization of reaction parameters.

The cavitation reactor apparatus with or without novel surface coating is further used in combination with ion exchange, alum treatment, Fenton, electro-Fenton, photo-Fenton, H₂O₂, ozone, Cl₂, ClO₂, and anaerobic and aerobic biological oxidation.

The pollutant and H₂O₂ are in a molar ratio range of 1:100 to 1:1000. The alum treatment includes applying aluminium sulphate to the waste or polluted water. The Fenton treatment involves the reaction of Fenton's reagent (iron salt in Fe²⁺ form) with hydrogen peroxide resulting in the generation of hydroxyl radical. Electro-Fenton treatment utilizes hydroxyl radicals to oxidize hazardous contaminants and is especially useful to treat recalcitrant compounds that are not easily degraded in conventional water and wastewater treatment plants. Photo-Fenton treatment is a combination of Fenton reagents and UV-Vis light that brings about additional OH radicals via (i) photo-reduction of ferric ions to ferrous ions and (ii) hydrogen peroxide photolysis.

The cavitation reactor apparatus with or without novel surface coating is used in combination with process intensifications selected from but not limited to type of the reactor, temperature, pressure, aeration, flow rate, mixing of gases/inert gases and the like.

The process and the cavitation reactor apparatus operate at nearly ambient conditions, with or without catalyst. The process can yield up to 100% degradation and is useful even at very high concentrations. The process requires comparatively low pressure drop in hydrodynamic cavitation and therefore lower cost of operation compared to other reported processes in the literature.

The process for degradation of pollutants by the cavitation reactor apparatus with or without novel surface coating can work effectively for a number of industrial wastewaters and with variety of pollutants. The wastewater includes but not limited to effluent from industrial or domestic including but not limited to Chemical process industries, wastewater treatment, pharmaceutical industries, specialty chemicals industries, hospital wastewater, paper industries, distilleries, textile and dyeing industries.

The process for degradation of pollutants in wastewater by the cavitation reactor apparatus with or without novel surface coating involves controlling parameters selected from, but not limited to, appearance, colour, odour, pH, total dissolved solids, total suspended solids, ammoniacal nitrogen, chemical oxygen demand and biological oxygen demand to within limits prescribed by environmental control agencies.

The process for degradation of pollutants in wastewater by the cavitation reactor apparatus with or without surface coating is carried out with pressure drops ranging from 0.5-2 bar, though pressure drop may depend on the nature/scale of operation.

The process for degradation of pollutants in wastewater by the cavitation reactor apparatus with or without novel surface coating operates at nearly ambient conditions, with the metal coating acting as a catalyst. The process can yield up to 100% degradation and is useful even at very high concentrations. The process requires comparatively low pressure drop in hydrodynamic cavitation and therefore lower cost of operation compared to other reported processes in the literature.

In a preferred embodiment of the invention, the cavitation reactor apparatus with or without novel surface coating effected with pollutant:H₂O₂ ratio ranging between 1:100 and 1:1000 mol ratio results in 75% to 100% degradation of pollutant, wherein the pollutant is selected from organic compounds selected from dyes, antibiotics, and the like.

In a preferred embodiment of the invention, the process and cavitation reactor apparatus with or without novel surface coating are useful for converting pollutants including antibiotics in wastewater or any other contaminated solutions, which are harmful for environment/public health into the degradation products or mineralization to water and carbon dioxide.

In another preferred embodiment of the invention, the process and the cavitation reactor apparatus with or without novel surface coating are useful for disinfecting the wastewater or any other contaminated solutions, which are harmful for environment/public health.

In an embodiment of the present invention, the one of the advantages of the surface coating described herein is that said surface coating is completely free of toxic chemicals and therefore is environmentally friendly.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

The following examples are given as a way of illustration only and should not be construed to limit the scope of the present invention.

The disclosure will now be illustrated with following examples, which is intended to illustrate the working of disclosure and not intended to take restrictively to imply any limitations on the scope of the present disclosure. Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and composites, the exemplary methods, devices, and materials are described herein. It is to be understood that this disclosure is not limited to particular methods, and experimental conditions described, as such methods and conditions may apply.

### Example: 1

Modified Acoustic Cavitation Process: Application of Copper Reactor in the Conventional Acoustic Cavitation for the Degradation of Antibiotics, Cephalexin (C₀=20 ppm)

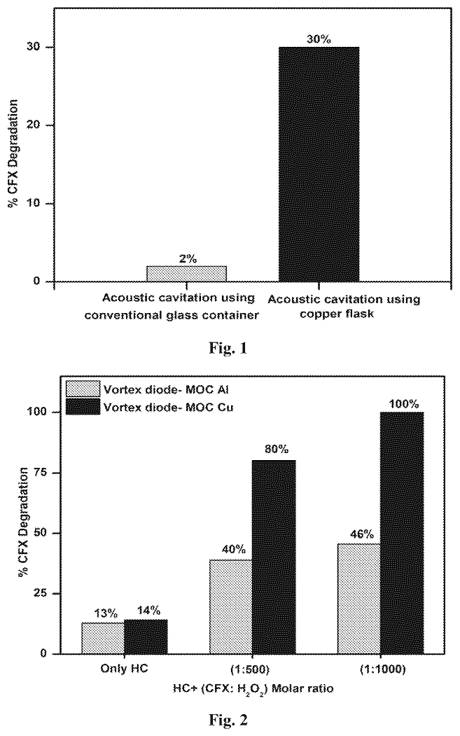

Acoustic cavitation was carried out using ultrasound 40 kHz frequency and 500 W power (UCP-20 Sonicator). Experiments were carried out for the degradation of cephalexin using glass reactor, stainless steel reactor, silver reactor and also using copper reactor. A volume of 200 mL of 20 ppm initial concentration was used. Degradation was carried out for 30 min. A degradation of 2% was obtained in reactors of glass, stainless steel (SS) and Silver while 30% degradation was obtained in copper reactor under similar conditions, indicating an enhancement of 1400% for the copper reactor in acoustic cavitation (Table 1 and FIG. 1).

TABLE 1
Degradation of cephalexin, C₀ = 20 ppm using Acoustic cavitation.

| | % Cephalexin degradation |
|---|---|
| Scheme | after 30 min |
| Acoustic cavitation using Glass reactor | 2 |
| Acoustic cavitation using SS reactor | 2 |
| Acoustic cavitation using Silver reactor | 2 |
| Acoustic cavitation using copper reactor | 30 |

### Example 2

Modified Hydrodynamic Cavitation Process: Copper as Material of Construction (MOC) for Vortex Diode with Process Intensification for Degradation of Antibiotics, Cephalexin (C₀=20 ppm)

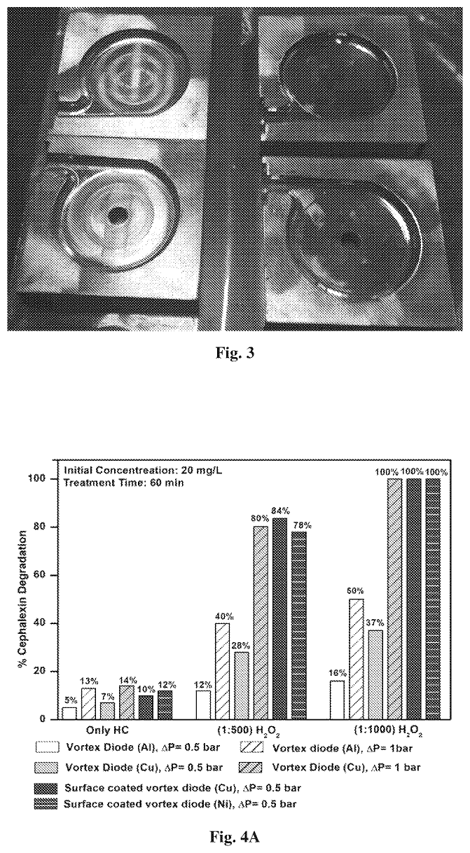

Experimental loop for degradation of antibiotics with disclosed invention was established. The nominal pipe diameter of ¾″ was used. The set up was equipped with pump capable of providing 1500 LPH flow. A storage tank of 50 L capacity was used for storage of contaminated water to be treated. Vortex diode of capacity 1 m³/h, with copper as MOC for cavitation reactor, was used as a cavitating device for generating vortex flow-based cavitation. Synthetic solution containing cephalexin as model refractory pollutant/antibiotic was used for degradation. Using process intensification with addition of H₂O₂ (1:1000 molar ratio) in the disclosed method, 100% of cephalexin degradation was obtained after 60 min treatment at ΔP of 1 bar (Table 2 and FIG. 2). The modified process yielded over 600% enhancement in degradation over conventional hydrodynamic cavitation alone and over 100% enhancement over process intensified conventional hydrodynamic cavitation.

TABLE 2
Degradation of cephalexin, C₀ = 20 ppm using Modified
Hydrodynamic Cavitation with Copper as MOC for vortex
diode and Process Intensification (ΔP = 1 bar).

| | Material of | % |
|---|---|---|
| | Construction for | Cephalexin |
| | cavitating device/reactor | degradation |
| | Vortex diode, | after |
| Scheme | ΔP = 1 bar | 60 min |
| Conventional hydrodynamic | Aluminum | 13 |
| cavitation | | |
| Modified hydrodynamic | Copper | 14 |
| Cavitation | | |
| Conventional hydrodynamic | Aluminum | 40 |
| cavitation with addition of H₂O₂ | | |
| (1:500 molar ratio) | | |
| Modified hydrodynamic | Copper | 80 |
| cavitation with addition of H₂O₂ | | |
| (1:500 molar ratio) | | |
| Conventional hydrodynamic | Aluminum | 46 |
| cavitation with addition of H₂O₂ | | |
| (1:1000 molar ratio) | | |
| Modified hydrodynamic | Copper | 100 |
| cavitation with addition of H₂O₂ | | |
| (1:1000 molar ratio) | | |

### Example 3

### Surface Coated Cavitation Reactors—Vortex Diode (Copper and Silver Coating) as Cavitation Reactors

Surface Coated Cavitation reactor (Chamber diameter 66 mm) with internal copper coating—Cu-50 micron was made. Similarly, Surface Coated Cavitation reactors with internal Nickel and Silver coating—each 50 micron coating thickness were also made for cavitation reactions and for different applications. The internal coating of the vortex diode for the copper and silver is shown in FIG. 3.

It is suggested that specific type of the coating will assist specific categories of the reactions. For example, copper catalyzed reactions can be best considered for the cavitation reactor coated with copper and silver catalyzed reactions can be best considered for applications of cavitation device having silver coating.

A thickness as less as 50 micron can be useful for driving the reaction, though a further smaller thickness of the coating or more thickness of the coating can be considered as per the need and after the optimization of reaction parameters.

The design and final appearance of the device is largely not altered and can be followed using the conventional practice of fabrication, except for applying suitable coating of the specified metal/material and for suitable thickness.

### Example 4

Surface Coated Vortex Diode (Copper Coating) in Hydrodynamic Cavitation Process: Copper Coated Vortex Diode with and without Process Intensification for Degradation Of Antibiotics, Cephalexin (C0=20 ppm).

Experimental loop for degradation of antibiotics with disclosed invention was established. The nominal pipe diameter of ¾″ was used. The set up was equipped with pump capable of providing 1500 LPH flow. A storage tank of 50 L capacity was used for storage of contaminated water to be treated. Surface Coated Vortex diode (Copper coating, nm) of capacity 1 m³/h, was used as a cavitating device for generating vortex flow based cavitation. The typical treatment time was 60 min and samples were withdrawn every 10 min.

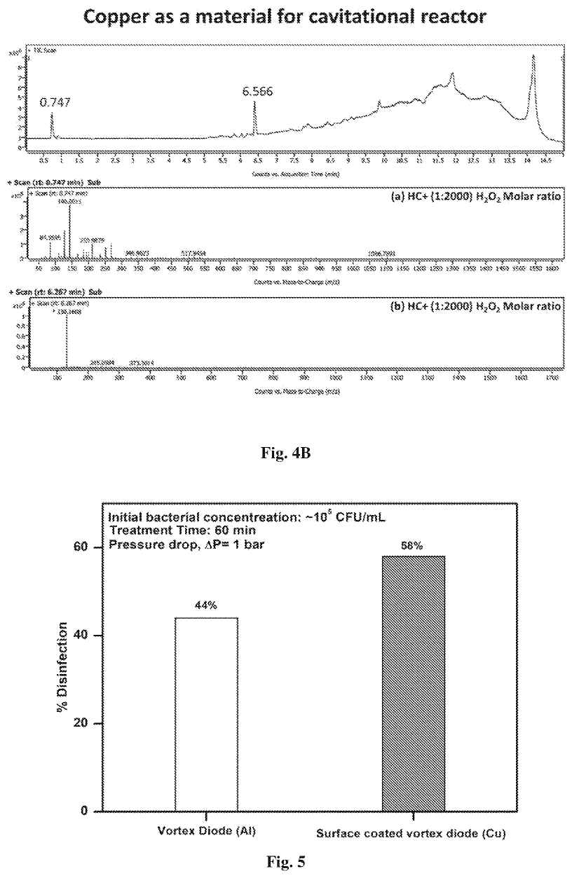

A 20 ppm initial concentration of cephalexin hydrate (CFX) was used for a model reaction system for the degradation using cavitation process. Different types of vortex diodes were employed as cavitating devices having different MOC as aluminum (Vortex diode-A1) and copper (Vortex diode-Cu) and new surface-coated vortex diode with copper coating (MOC SS316 for the Vortex diode and Cu coating internally). The optimized pressure drop for the surface-coated vortex diode (Cu) was 0.5 bar which is significantly lower than others (100% lower). The reaction was also evaluated for the process intensification approach using hydrogen peroxide (H₂O₂) at different loadings using molar ratios of CFX: H₂O₂ as (1:500) and (1:1000). A strong effect was observed using the hydrogen peroxide addition, though the results were comparable without hydrogen peroxide addition. The extent of degradation was ~85% using surface coated vortex diode compared to ~40% using aluminium vortex diode for molar ratio of CFX: H₂O₂ as 1:500. The catalytic action due to copper is evident from more than 100% increased degradation of CFX in copper vortex diode and also in the surface coated vortex diode as compared to aluminium vortex diode (Table-3; FIG. 4A). Further, a significant reduction in the pressure drop using surface-coated vortex diode can be achieved for the complete degradation of CFX, indicating cost-effectiveness compared to the conventional process.

The enhancement of ~1900% in degradation using process intensification was observed over conventional hydrodynamic cavitation alone over 500% enhancement over process intensified conventional hydrodynamic cavitation.

Further, 4B represents the graph of 2 byproducts formed by the degradation of CFX using copper as coating material for the cavitation reactor, after 60 minutes of treatment.

### Example 5

Surface Coated Vortex Diode (Nickel Coating) in Hydrodynamic Cavitation Process: Nickel Coated Vortex Diode with and without Process Intensification for Degradation Of Antibiotics, Cephalexin (C₀=20 ppm)

Experimental loop for degradation of antibiotics with disclosed invention was established. The nominal pipe diameter of ¾″ was used. The set up was equipped with pump capable of providing 1500 LPH flow. A storage tank of 50 L capacity was used for storage of contaminated water to be treated. Surface Coated Vortex diode (Nickel coating, ~50 micron) of capacity 1 m³/h, was used as a cavitating device for generating vortex flow based cavitation. The typical treatment time was 60 min and samples were withdrawn every 10 min. A 20 ppm initial concentration of cephalexin hydrate (CFX) was used for a model reaction system for the degradation using cavitation process. Different types of vortex diodes were employed as cavitating devices having different MOC as aluminium (Vortex diode-A1) and copper (Vortex diode-Cu) and new surface-coated vortex diode with Nickel coating (MOC SS316 for the Vortex diode and Ni coating internally). The optimized pressure drop for the surface-coated vortex diode (Ni) was 0.5 bar which is significantly lower than others (100% lower). The reaction was also evaluated for the process intensification approach using hydrogen peroxide (H₂O₂) at different loadings using molar ratios of CFX: H₂O₂ as (1:500) and (1:1000). A strong effect was observed using the hydrogen peroxide addition, though the results were comparable without hydrogen peroxide addition. The extent of degradation was ~78% using surface coated vortex diode compared to ~40% using aluminium vortex diode for molar ratio of CFX: H₂O₂ as 1:500. The catalytic action due to Nickel was evident from more than 100% increased degradation of CFX in the surface coated vortex diode as compared to aluminium vortex diode (Table-3; FIGS. 4A and B). Further, a significant reduction in the pressure drop using surface-coated vortex diode was achieved for the complete degradation of CFX, indicating cost-effectiveness compared to the conventional process.

The enhancement of ~1900% in degradation using process intensification was observed over conventional hydrodynamic cavitation alone over 500% enhancement over process intensified conventional hydrodynamic cavitation.

TABLE 3
Degradation of cephalexin using surface
coated vortex diode (C₀ = 20 ppm).

| | | | | % |
|---|---|---|---|---|
| | | Material of | Pressure | Ceph- |
| | | construction | drop | alexin |
| Catalytic | | (MOC)/ | across | degra- |
| Vs Non- | | Surface | vortex | dation |
| Catalytic | | coating | diode | after 60 |
| activity | Scheme | material | (ΔP) | min |
| Non- | Conventional vortex | MOC: | 0.5 | 5 |
| Intensified | diode | Aluminium | | |
| Action of | Conventional vortex | MOC: | 1 | 13 |
| Vortex | diode | Aluminium | | |
| Diode | Vortex Diode | MOC: | 0.5 | 7 |
| | | Copper | | |
| | Vortex Diode | MOC: | 1 | 14 |
| | | Copper | | |
| | Surface coated vortex | Coating: | 0.5 | 10 |
| | diode | Cu | | |
| | Surface coated vortex | Coating: Ni | 0.5 | 12 |
| | diode | | | |
| Intensified | Conventional vortex | MOC: | 0.5 | 12 |
| Action of | diode with addition of | Aluminium | | |
| Vortex | H₂O₂ | | | |
| Diode | (1:500 molar ratio) | | | |
| (1:500 | Conventional vortex | MOC: | 1 | 40 |
| molar | diode with addition | Aluminium | | |
| ratio) | of H₂O₂ | | | |
| | (1:500 molar ratio) | | | |
| | Vortex diode with addition | MOC: | 0.5 | 28 |
| | of H₂O₂ | Copper | | |
| | (1:500 molar ratio) | | | |
| | Vortex diode with addition | MOC: | 1 | 80 |
| | of H₂O₂ | Copper | | |
| | (1:500 molar ratio) | | | |
| | Surface coated vortex | Coating: | 0.5 | 84 |
| | diode with addition | Copper | | |
| | of H₂O₂ (1:500 molar ratio) | | | |
| | Surface coated vortex | Coating: | 0.5 | 78 |
| | diode with addition | Nickel | | |
| | of H₂O₂ (1:500 molar ratio) | | | |
| Intensified | Conventional vortex diode | MOC: | 0.5 | 16 |
| Action of | with addition of H₂O₂ | Aluminium | | |
| Vortex | (1:1000 molar ratio) | | | |
| Diode | Conventional vortex diode | MOC: | 1 | 50 |
| (1:1000 | with addition of H₂O₂ | Aluminium | | |
| molar | (1:1000 molar ratio) | | | |
| ratio) | Vortex diode with addition | MOC: | 0.5 | 37 |
| | of H₂O₂ | Copper | | |
| | (1:1000 molar ratio) | | | |
| | Vortex diode with addition | MOC: | 1 | 100 |
| | of H₂O₂ | Copper | | |
| | (1:1000 molar ratio) | | | |
| | Surface coated vortex | Coating: | 0.5 | 100 |
| | diode with addition | Copper | | |
| | of H₂O₂ | | | |
| | (1:1000 molar ratio) | | | |
| | Surface coated vortex | Coating: | 0.5 | 100 |
| | diode with addition | Nickel | | |
| | of H₂O₂ | | | |
| | (1:1000 molar ratio) | | | |

### Example 6

### Catalytic Hydrodynamic Cavitation Using Surface Coated Vortex Diode (Copper) for the Disinfection of Water:

The experimental set-up consisted of a 50 L water holding tank with conical outlet, centrifugal pump with a discharge pressure range of 0-15 bar, control valves, SS pipes with the diameter of ¾″, shell and tube chiller for maintaining the temperature of the synthetic solution and, cavitating device-Vortex diode in the mainline. Copper surface coated vortex diode with the capacity of 1 m³/h was employed as a cavitating device. The contaminated water with ~10⁵ CFU/mL of initial concentration of E. coli bacteria was used for the disinfection study. The catalytic cavitation using copper coated surface modified vortex diode gave 58% disinfection compared to only 44% with conventional vortex diode (A1) under similar conditions (FIG. 5). The enhancement of over 30% in disinfection was observed in comparison to conventional vortex diode.

### Example 7: Synergistic Indices for Cephalexin (CFX) and Ciprofloxacin (CIP)

The synergistic index of the combined approach of HC+pH+H₂O₂ was calculated on the obtained kinetic rate constants for both antibiotics at optimized pH conditions; pH 11 for CFX and pH 4 for CIP. The synergistic values are represented in Table 4.

TABLE 4
Synergistic indices for different treatment approaches

| | Conventional | Cu- | Ni |
|---|---|---|---|
| | Al-vortex | coated cortex | coated vortex |
| CFX degradation | diode | diode | diode |
| HC + H₂O₂ | 3.2 | 18.7 | 177.1 |
| HC + H₂O₂ + pH | 5.4 | 28.4 | 19.5 |
| HC + H₂O₂ | 1 | 189.2 | 142.4 |
| HC + H₂O₂ + pH | 1.9 | 11.8 | 11.8 |

Significantly high values of 28.4, and 11.8 for CFX and CIP, respectively for the process intensification approach were achieved using surface-coated vortex diodes which confirms the excellent synergism over the conventional vortex diode as well as an individual approach.

### Example 8: Enhanced Degradation of Metformin Using Surface-Coated Vortex Diodes

The degradation of metformin was studied using three different vortex-flow based cavitation reactors. An aluminium vortex diode (A1 vortex diode) was used for non-catalytic degradation. Reactor modification for the two new non-conventional surface-coated vortex diodes having copper (Cu-SCVD) and nickel (Ni-SCVD) as the internal surface coating (50-55 m) was evaluated for the additional catalytic activity of the cavitation reactor. All the degradation studies were carried out using conventional as well as both newer surface-coated vortex diodes under similar operating conditions for comparing the enhancement in the efficiency and substantiate the catalytic effect due to reactor modification. To further enhance the catalytic activity, process intensification using hydrogen peroxide as a green oxidant was investigated at various molar ratios of (Metformin: H₂O₂) as 1:100 (0.4 μg/L), 1:200 (0.8 μg/L), 1:500 (2 μg/L), and 1:1000 (4 μg/L). Another process intensification was studied by modifying the pH to acidic (pH 4), basic (pH 9), and along with the combined approach of pH and H₂O₂. The degradation studies were carried out for 60 min time and samples were taken at 5-10 min intervals. The reproducibility was confirmed, and the deviation was found within ±5%.

The dual activity of surface-coated cavitation reactors was explored using copper and nickel surface-coated vortex diodes and the efficiencies were compared with conventional non-catalytic vortex diode (A1-vortex diode). In view of inception of the cavitation in the vortex diode at ~0.48 bar and reported literature apart from preliminary experiments, a pressure drop of 1 bar was considered for all the experiments.

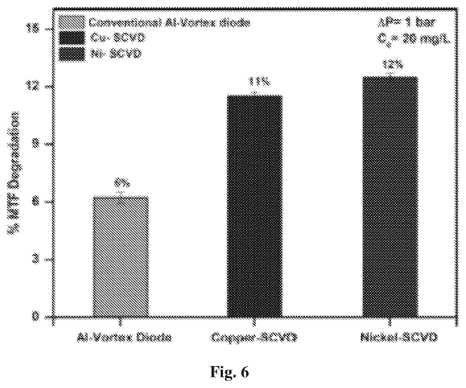

The degradation results for all the devices, non-catalytic as well as catalytic without any intensification are shown in FIG. 6. An enhancement from 6% to 12% in MTF degradation is seen, though small degradation value, enhancement of 100% due to additional catalytic activity. The TOC reduction was negligible for the conventional A1 vortex diode, while 8-10% TOC reduction was achieved for SCVDs. A pseudo-first-order model fit for the kinetics and the corresponding values are given in Table 5. The rate constant value for conventional A1 vortex diode was 1.1×10⁻³ min⁻¹ corresponding to higher value of ~2.2×10⁻³ min⁻¹ for surface-coated vortex diodes, indicating 100% enhancement in the degradation rate of MTF. In general, the result of low degradation of MTF agrees with the earlier report—where the conventional vortex diode, made up of stainless steel, was used for the study of MTF degradation, and a meagre reduction of 3-5% was achieved for various concentrations in 60 min.

The degradation of 12% is far from being satisfactory for industrial applications and therefore the enhancement due to the catalytic devices need to be further explored in hydrodynamic cavitation using process intensification/modifications.

TABLE 5
MTF degradation and rate constants for conventional
and surface coated devices.

| | (%) Metformin degradation in 60 min | | |
|---|---|---|---|
| Process | Degradation | TOC Reduction | k × 10³ |
| Only H₂O₂ | 1 | 0 | 0.1 |
| Cu + H₂O₂ | 3 | 1.2 | 0.6 |
| Ni + H₂O₂ | 3 | 1.5 | 0.6 |

Conventional Al-vortex diode

| | | | |
|---|---|---|---|
| Only HC | 6 | 3 | 1.1 |
| HC + (1:100) H₂O₂ | 14 | 5 | 2.6 |
| HC + (1:200) H₂O₂ | 24 | 12 | 4.7 |
| HC + (1:500) H₂O₂ | 36 | 15 | 7.1 |
| HC + (1:1000) H₂O₂ | 43 | 19 | 9.3 |
| HC + pH 4 | 32 | 22 | 6.4 |
| HC + pH 11 | 19 | 14 | 3.5 |
| HC + pH 4 + H₂O₂ | 52 | 25 | 12.2 |

Copper surface-coated vortex diode

| | | | |
|---|---|---|---|
| Only HC | 11 | 8 | 2.1 |
| HC + (1:100) H₂O₂ | 17 | 11 | 3.1 |
| HC + (1:200) H₂O₂ | 22 | 26 | 4.2 |
| HC + (1:500) H₂O₂ | 91 | 37 | 240.8 |
| HC + (1:1000) H₂O₂ | 100 | 38 | 921 |
| HC + pH 4 | 63 | 32 | 16.5 |
| HC + pH 11 | 22 | 20 | 4.1 |
| HC + pH 4 + H₂O₂ | 100 | 43 | 921 |

Nickel surface-coated vortex diode

| | | | |
|---|---|---|---|
| Only HC | 12 | 10 | 2.2 |
| HC + (1:100) H₂O₂ | 19 | 16 | 3.4 |
| HC + (1:200) H₂O₂ | 89 | 27 | 221.6 |
| HC + (1:500) H₂O₂ | 100 | 42 | 921 |
| HC + (1:1000) H₂O₂ | 100 | 28 | 921 |
| HC + pH 4 | 74 | 39 | 22.6 |
| HC + pH 11 | 31 | 23 | 6.2 |
| HC + pH 4 + H₂O₂ | 100 | 48 | 921 |

Example 8 showed complete degradation of metformin using newer surface-coated vortex diode (SCVD) with copper and nickel coating to provide catalytic activity in the conventional hydrodynamic cavitation (H₁C) for significantly enhanced degradation efficiency.

### Advantages of the Invention

The present invention provides a dual activity catalytic cavitation reactor apparatus without moving elements to achieve high rates of reaction/high extent of degradation and huge enhancement in degradation efficiency

The present invention provides a catalytic cavitation reactor apparatus with or without surface coating for the removal of pollutants, enhanced degradation efficiency, especially for the removal of antibiotics, in general, and completes degradation.

The present invention provides a dual activity cavitation reactor apparatus with or without surface coating for effecting various catalytic reactions including degradation.

The present invention provides a dual activity cavitation reactor apparatus with or without surface coating for enhancing reaction efficiency compared to conventional designs.

The present invention provides a dual activity cavitation reactor apparatus with or without surface coating that employs the use of lower pressure drop and mild operating conditions for 100% degradation of various types of pollutants.

The present invention provides catalytic cavitation process and catalytic cavitation reactor without use of harmful chemicals such as acids.

The present invention provides catalytic cavitation process and catalytic cavitation reactor with possible drastic reduction in the process cost due to increased reaction rates/reduced processing time.

1. A cavitation process for degradation of pollutants in wastewater comprising:
a. introducing 10 mg/L to 30 mg/L wastewater having pollutants in a cavitation reactor; and
b. contacting the wastewater in a dual activity cavitation reactor having a coating on inner side(s) of the cavitation reactor at a pressure drop is in the range of 0.5 to 2 bar, in presence or absence of H2O2, at a pH in the range of 4 to 14 and temperature in the range of 0 to 200° C. for a period in the range of 5 min to 90 min to degrade the pollutants.

2. The process as claimed in claim 1, wherein the cavitation reactor is made of a material selected from a group consisting of metal, glass, tile, stone, polymer, quartz, plastic, ceramic surfaces, polymeric surfaces and combination thereof.

3. The process as claimed in claim 1, wherein the cavitation reactor is a hydrodynamic cavitating device made up of a metal selected from copper, aluminium, and stainless steel.

4. The process as claimed in claim 1, wherein the cavitation reactor is selected from orifice, venturi, vortex diode, and rotating impeller.

5. The process as claimed in claim 1, wherein the coating is comprised of a metal selected from a group consisting of Fe, Cu, Co, Ag, Ni, Au, or salts thereof, and combination thereof.

6. The process as claimed in claim 5, wherein the coating has a thickness in the range of 10 μm to 100 μm.

7. The process as claimed in claim 1, wherein step (b) is carried out optionally with ion exchange, alum treatment, Fenton, electro-Fenton, photo-Fenton, ozone, Ch, Cl02, or anaerobic and aerobic biological oxidation.

8. The process as claimed in claim 1, wherein the pollutants are organic compounds.

9. The process as claimed in claim 1, wherein the pollutant and H2O2 molar ratio is in the range of 1:100 to 1:1000.
